(19) United States
(12) Patent Application Publication
(10) Pub. No.: US 2005/0246498 A1
(43) Pub. Date: Nov. 3, 2005

(54) Instruction cache and method for reducing memory conflicts

(76) Inventors: Doron Schupper, Nachum Kesselman (IT); Yakov Tokar, Ashdod (IT); Jacob Efrat, Kfar Saba (IT)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/512,699

(22) PCT Filed: Mar. 3, 2003
(86) PCT No.: PCT/EP03/02222

§ 371 Date: Oct. 26, 2004

(30) Foreign Application Priority Data
Apr. 26, 2002 (GB) 0209572.7

(51) Int. Cl. G06F 12/00

(52) U.S. Cl. 711/125; 711/168; 711/3

(57) ABSTRACT

Read/write conflicts in an instruction cache memory (11) are reduced by configuring the memory as two even and odd array sub-blocks (12,13) and adding an input buffer (10) between the memory (11) and an update (16). Contentions between a memory read and a memory write are minimised by the buffer (10) shifting the update sequence with respect to the read sequence. The invention can adapt itself for use in digital signal processing systems with different external memory behaviour as far as latency and burst capability is concerned.

This invention relates to an instruction cache and its method of operation and particularly to reducing conflicts in a cache memory.

Cache memories are used to improve the performance of processing systems and are often used in conjunction with a digital signal processor (DSP) core. Usually, the cache memory is located between an external (often slow) memory and a fast central processing unit (CPU) of the DSP core. The cache memory typically stores data such as frequently used program instructions (or code) which can quickly be provided to the CPU on request. The contents of a cache memory may be flushed (under software control) and updated with new code for subsequent use by a DSP core. A cache memory or cache memory array forms a part of an instruction cache.

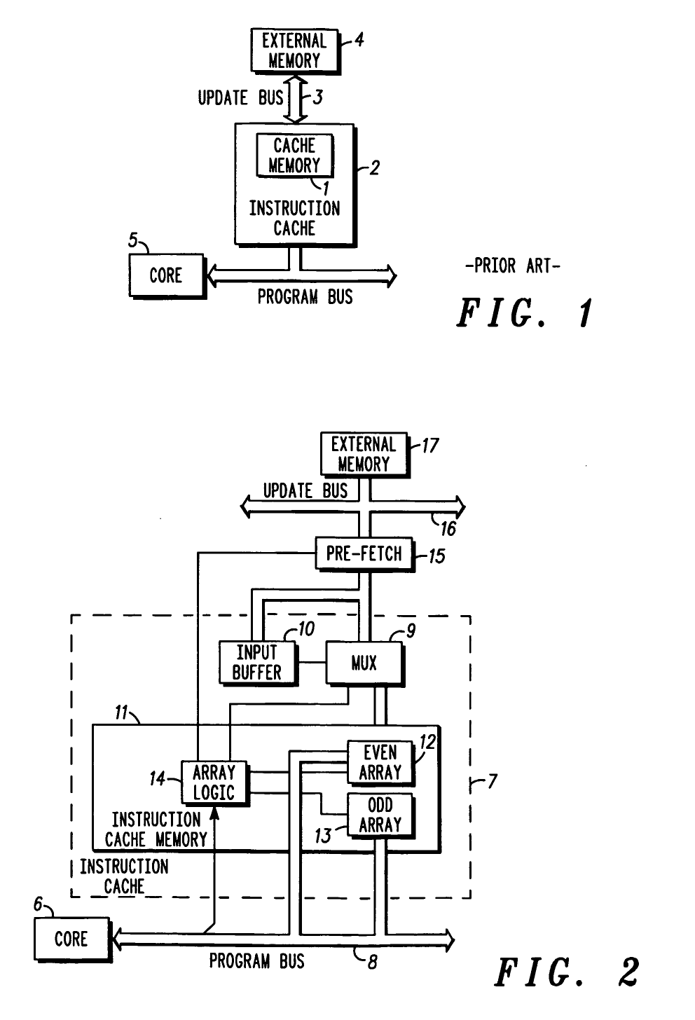

In FIG. 1, a cache memory 1 forming part of an instruction cache 2 is updated (via an update bus 3) with code stored in an external memory 4. A DSP core 5 accesses the instruction cache 2 and its memory 1 by way of a program bus. When the core 5 requests code that is already stored in the cache memory 1, this is called a “cache hit”. Conversely, when the core 5 requests code that is not currently stored in the cache memory 1, this is called a “cache miss”. A “cache miss” requires a “fetch” of the required code from the external memory 4. This “fetch” operation is very time consuming, compared with the task of accessing the code directly from the cache memory 1. Hence, the higher the hit-to-miss ratio, the better the performance of the DSP. Therefore, a mechanism for increasing the ratio would be advantageous.

Co-pending U.S. application Ser. No. 09/909,562 discloses a pre-fetching mechanism whereby a pre-fetch module, upon a cache miss, fetches the required code from an external memory and loads it into the cache memory and then guesses which code the DSP will request next and also loads such code from the external memory into the cache memory. This pre-fetched code address is consecutive to the address of the cache miss. However, conflicts can arise in the cache memory due to the simultaneous attempts to read code from the cache memory (as requested by the DSP) and update the cache memory (as a result of the pre-fetch operation). That is to say that not all reads and writes can be performed in parallel. Hence, there can be degradation in DSP core performance since one of the contending access sources will have to be stalled or aborted. Further, due to the sequential nature of both DSP core accesses and pre-fetches, a conflict situation can last for several DSP operating cycles.

Memory interleaving can partially alleviate this problem. U.S. Pat. No. 4,818,932 discloses a random access memory (RAM) organised into an odd bank and an even bank according to the state of the least significant bit (LSB) of the address of the memory location to be accessed. This arrangement provides a reduction in waiting time for two or more processing devices competing for access to the RAM. However, due to the sequential nature of cache memory updates and DSP requests, memory interleaving alone does not completely remove the possibility of conflicts. Hence, there is a need for further improvement in reducing the incidence of such conflicts.

According to a first aspect of the present invention, there is provided an instruction cache for connection between a processor core and an external memory, the instruction cache including a cache memory composed of at least two sub-blocks, each sub-block being distinguishable by one or more least significant bits of a memory address, means for receiving from the processor core a request to read a required data sequence from the cache memory, and a buffer for time-shifting an update data sequence, received from the external memory for writing into the cache memory, with respect to the required data sequence, thereby to reduce read/write conflicts in the cache memory sub-blocks.

According to a second aspect of the present invention, there is provided a method for reducing read/write conflicts in a cache memory which is connected between a processor core and an external memory, and wherein the cache memory is composed of at least two memory sub-blocks, each sub-block being distinguishable by one or more least significant bits of a memory address, the method including the steps of;
receiving a request from the processor core for reading from the cache memory a required data sequence,
receiving from the external memory an update data sequence for writing into the cache memory, and
time shifting the update sequence with respect to the required data sequence by buffering the update data, thereby to reduce read/write conflicts in the cache memory sub-blocks.

The invention is based on the assumption that core program requests and external updates are sequential for most of the time.

In one embodiment, the cache's memory is split into two sub-blocks where one is used for the even address and the other for the odd addresses. In this way, a contention can occur only if both the core's request and the update are to addresses with the same parity bit.

In general, memory sub-blocks are distinguished by the least significant bits of the address. However, merely providing multiple memory sub-blocks will not prevent sequential updates via a pre-fetch unit colliding with sequential requests from a DSP core in all cases, as the memory sub-bock can only support either one read (to the DSP core) or one update (from the external memory via the pre-fetch unit).

The buffer serves to buffer one single contention which breaks a possible sequence of updates versus DSP core requests. The buffer's entry/input port may be connected to the update bus port of the cache memory and arranged to feed all memory sub-blocks.

Hence, the invention combines a minimal buffering with a specific memory interleave which results in a very small core performance penalty.

In one embodiment the buffer samples the update bus every cycle. The data sequence written into the cache memory however, need not always be the buffered data. For example, in instances where there is no reason to delay a write operation, then the update data is written directly into the cache memory, by-passing the buffer. Hence there is a multiplexing of update data flowing into the cache memory; either via the buffer or directly from the external memory. Preferably, selector means are provided for selecting a data sequence either from the buffer or from a route by-passing the buffer.

The arbitration mechanism in case of a memory conflict is simple. If the conflict is between external buses, then the invention serves to buffer the update bus and serve the core or else stall the core and write the buffer's data into the cache memory.

The invention also eliminates the need to use some sequence defining protocol. Sequences are inherently recognised and dealt with by the invention as any other input. The interface to the core and external memory can also be very simple. The external memory stays oblivious of all cache arbitration and the core only needs a stall signal.

The above advantages allow the invention to fit smoothly into a vast array of memory system configurations. Also, only a single stage buffer is required. Further penalty reduction can be achieved, without massive re-design, by dividing the cache's memory into smaller sub-blocks and using more least significant bits for the interleave.

Some embodiments of the invention will now be described, by way of example only, with reference to the drawings of which;

FIG. 1 is a block diagram of a known instruction cache arrangement,

FIG. 2 is a bock diagram of a processing system including an instruction cache in accordance with the present invention, and

FIGS. 3 to 5 are timing diagrams illustrating operation of the invention under three different circumstances.

In FIG. 2, a DSP core 6 can gain access to an instruction cache 7 via a program bus 8. The instruction cache includes a multiplexer module 9, an input buffer 10 and cache memory 11. The cache memory 11 comprises an even array memory sub-block 12 and an odd array sub-block 13 and an array logic module 14, the latter being connected to the program bus 9 and both memory blocks 11, 12. The array logic module 14 is also connected to the multiplexer module 9 and a pre-fetch unit 15 external to the instruction cache. The pre-fetch unit 15 has connections to the input buffer 10 the multiplexer module 9 and an update bus 16. An external memory 17 is connected to the update bus 16.

The input buffer 10 always samples the update bus 16 via the pre-fetch unit 15 and allows each cache memory sub-block 12, 13 to alternate between update (write) and access (read) operations on alternate DSP clock cycles eg by buffering code fetched by the pre-fetch unit 15 until a conflicting read operation has been completed.

The pre-fetch unit 15 operates as follows. When the core 7 sends a request via the array logic module 14 requesting access to code from the cache memory 11 which is not actually in either memory sub-block, a miss indication is sent from the array logic module 14 to the pre-fetch unit 15. On receipt of the miss instruction, the pre-fetch unit 15 starts to fetch (sequentially) a block of code from the external memory 17 starting from the miss address. The block size is a user-configurable parameter that is usually more than one core request. Hence, a single cache miss generates a series of sequential updates to the cache memory 11 via the input buffer 10. The timing between updates (ie the latency) depends on the time that it takes consecutive update requests from the pre-fetch unit 15 to reach the external memory 17 and for the requested code to arrive at the input buffer 10. The updates may be several DSP operating cycles apart. However, the invention can adapt itself to use in the systems with different external memory behaviour as far as latency and burst capability is concerned.

When the array logic module 14 detects that a read/write contention exists—it signals to the multiplexer module 9 to load the data sequence currently stored in the input buffer 10 into the cache memory 11. When no contention exists, the array logic module 14 instructs the multiplexer module 9 to load data into the cache memory 11 directly from the pre-fetch unit 15.

FIG. 3 illustrates operation of the processing system of FIG. 2 in the case where there is high latency between updates. A read sequence P0, P1, P2, P3, P4, P5 switching alternately between even and odd memory arrays, and a write sequence U0, U1, U2, U3, U4 also switching between even and odd arrays on each DSP clock cycle are shown. During clock cycle T0, the update bus carries code U0 for loading into the even array and the DSP also wishes to read code P0 from the even array. Hence, there will be internal contention P0-U0. To alleviate this, the buffer stores U0 for one clock cycle T0 and then loads it (memory write) into the even array during the subsequent clock cycle T1, while the DSP is accessing the odd array (read P1). Similarly, subsequent read/write sequences, P1-P5 and U1-U4, are performed in parallel with no performance penalty. Thus, by shifting the update sequence by one cycle, by means of the buffer, and taking advantage of even/odd memory interleaving, both sequences can be handled without any core stall.

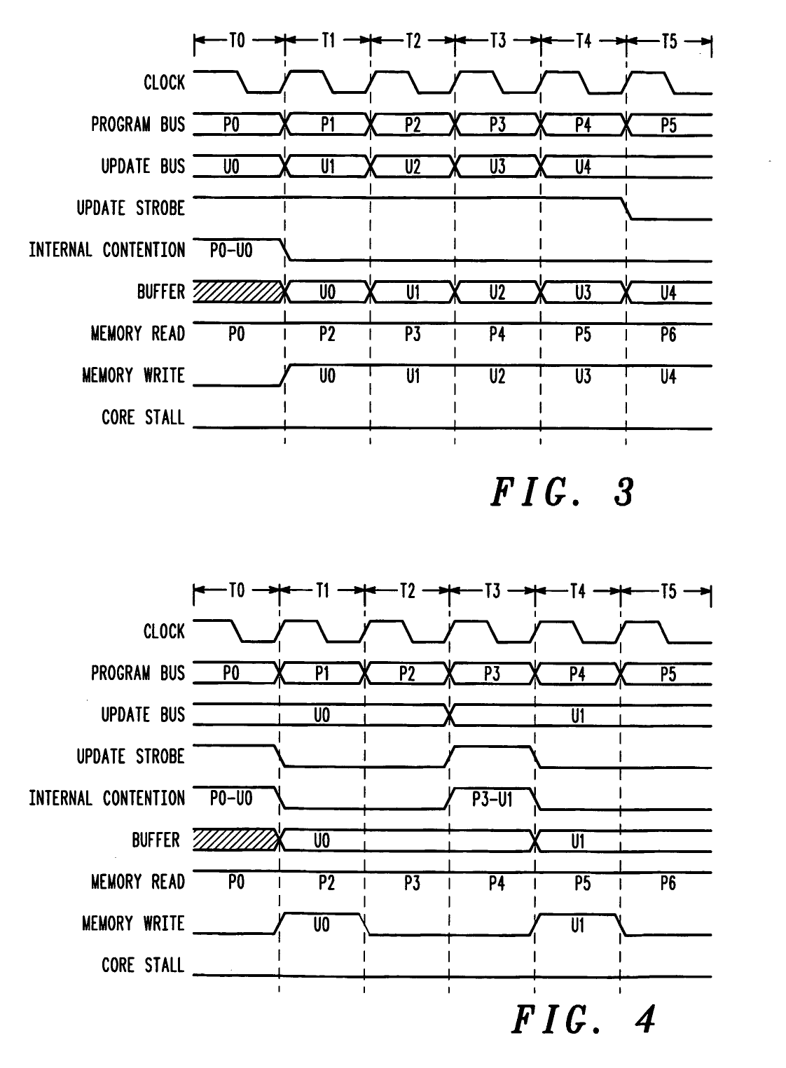

FIG. 4 illustrates the operation of the invention in a processing system with large latency between updates and shows a read sequence P0, P1, P2, P3, P4, P5 switching alternately between even and odd memory arrays on each DSP clock cycle. A write sequence U0, U1 alternates between the even and odd array after three clock cycles. During clock cycle T0 and T3 there is the possibility of internal contention P0-U0 and P3-U1. To alleviate this, the input buffer acts to shift the conflicting update (memory write) by one clock cycle so that U0 and U1 are written from the buffer whilst P1 and P4 are being read. Core stall is thus avoided.

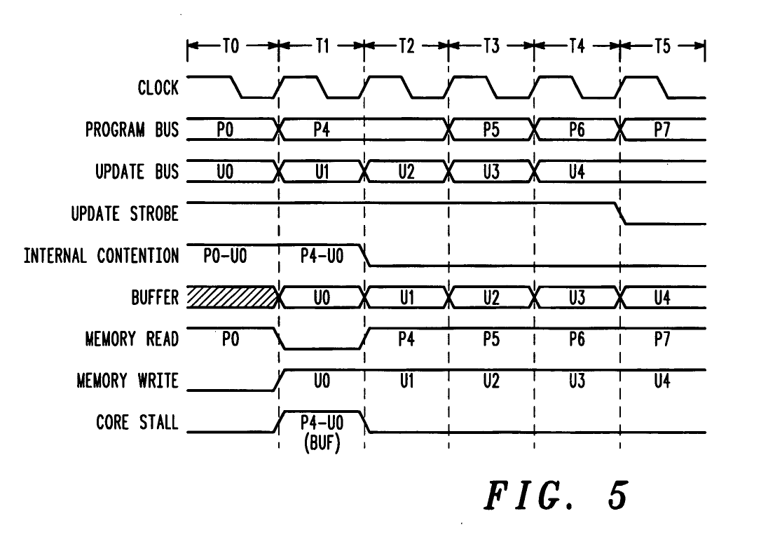

FIG. 5 illustrates a case where the DSP core will be stalled in those cases where the shifted update will collide with the new core request, ie when two consecutive core requests have the same least significant bits. Even in such cases, the invention reduces the penalty to one DSP clock cycle, since now the new core's sequence is shifted with respect to the update sequence. The read sequence in this example is P0 during the first clock cycle T0, P4 during clock cycles T1 and T2, and P5, P6, P7 during clock cycles T3, T4 and T5 respectively. The updates consists of U0, U1, U2, U3, U4 during clock cycles T0, T1, T2, T3 and T4 respectively. Hence, without any buffering there is the possibility of contention (and core stall) during clock cycles T0, T2, T3 and T4. By shifting the update sequence by one clock cycle (by the action of the input buffer), call stall can be reduced to just one clock cycle.

1. An instruction cache for connection between a processor core and an external memory, the instruction cache including a cache memory composed of at least two sub-blocks, each sub-block being distinguishable by one or more least significant bits of a memory address, means for receiving from the processor core a request to read a required data sequence from the cache memory, and a buffer for time shifting an update data sequence, received from the external memory for writing into the cache memory, with respect to the required data sequence, thereby to reduce read/write conflicts in the cache memory sub-blocks.

2. An instruction cache as claimed in claim 1 in which the cache memory is divided into two sub-blocks, one having even addresses and the other having odd addresses.

3. An instruction cache as claimed in claim 1 and further including means for selecting an update data sequence for writing into the cache memory from either the buffer or directly from the external memory via a route by-passing the buffer.

4. A method for reducing read/write conflicts in a cache memory which is connected between a processor core and an external memory, and wherein the cache memory is composed of at least two memory sub-blocks, each sub-block being distinguishable by one or more least significant bits of a memory address, the method including the steps of:
receiving a request from the processor core for reading from the cache memory a required data sequence,
receiving from the external memory an update data sequence for writing into the cache memory, and
time shifting the update sequence with respect to the required data sequence by buffering the input data, thereby to reduce read/write conflicts in the cache memory sub-blocks.

5. (canceled)

6. (canceled)

7. An instruction cache for connection between a processor core and an external memory, the instruction cache including a cache memory composed of at least two sub-blocks, each sub-block being distinguishable by one or more least significant bits of a memory address, a circuit for receiving from the processor core a request to read a required data sequence from the cache memory, and a buffer for time shifting an update data sequence, received from the external memory for writing into the cache memory, with respect to the required data sequence, thereby to reduce read/write conflicts in the cache memory sub-blocks.

8. An instruction cache as claimed in claim 1 in which the cache memory is divided into two sub-blocks, one having even addresses and the other having odd addresses.

9. An instruction cache as claimed in claim 1 and further including a circuit for selecting an update data sequence for writing into the cache memory from either the buffer or directly from the external memory via a route by-passing the buffer.
